(19) United States
(12) Patent Application Publication
(10) Pub. No.: US 2020/0332869 A1
(43) Pub. Date: Oct. 22, 2020

(54) SLIDER RAIL FOR A V-BELT PULLEY DRIVE

(71) Applicant: Schaeffler Technologies AG & Co. KG, Herzogenaurach (DE)

(72) Inventor: Nicolas Schehrer, Eschau (FR)

(73) Assignee: Schaeffler Technologies AG & Co. KG, Herzogenaurach (DE)

(21) Appl. No.: 16/766,057

(22) PCT Filed: Nov. 9, 2018
(86) PCT No.: PCT/DE2018/100910

§ 371 Date: May 21, 2020

(30) Foreign Application Priority Data
Dec. 8, 2017 (DE) 10 2017 129 207.1
Feb. 23, 2018 (DE) 10 2018 104 094.6

(51) Int. Cl. F16H 7/20; F16H 55/49; F16H 7/02

(52) U.S. Cl. CPC F16H 7/20; F16H 2007/185; F16H 7/02; F16H 55/49

(57) ABSTRACT

A slide rail for a V-belt pulley drive includes an outer guide for guiding an outside of an axially extending V-belt, and an inner guide for guiding an inside of the V-belt. One of the guides includes a first guide part with a first hook and a contact face, and a second guide part with a first hook receiver and a support face. The first guide part and the second guide part are connectable via the first hook and retained by a clip-tooth connection, acting in an axial direction, between the contact face and the support face. A V-belt pulley drive is also disclosed. The V-belt pulley drive includes a first pulley sheave pair arranged on a first shaft, a second pulley sheave pair arranged on a second shaft, an axially extending V-belt for transmitting torque between the pulley sheave pairs, and the slide rail arranged to guide the V-belt.

### CROSS-REFERENCE TO RELATED APPLICATIONS

This application is the United States National Phase of PCT Appln. No. PCT/DE2018/100910 filed Nov. 9, 2018, which claims priority to German Application Nos. DE102017129207.1 filed Dec. 8, 2017 and DE102018104094.6 filed Feb. 23, 2018, the entire disclosures of which are incorporated by reference herein.

### TECHNICAL FIELD

The disclosure concerns a slide rail for a V-belt pulley drive which is suitable for use in a motor vehicle. The V-belt pulley drive includes at least a first pulley sheave pair arranged on a first shaft and a second pulley sheave pair arranged on a second shaft, and a belt means for transmitting torque between the pulley sheave pairs.

### BACKGROUND

The V-belt pulley drive is in particular a CVT drive (continuously variable transmission), preferably for a motor vehicle. In particular, the V-belt pulley drive is used in conjunction with an internal combustion engine or another drive unit for driving a motor vehicle.

Such a V-belt pulley drive normally includes at least a first pulley sheave pair and a second pulley sheave pair, each with a first pulley sheave which can be displaced along the shaft axis and a second pulley sheave which is fixed in the direction of the shaft axis, and a belt means which is provided for transmitting torque between the pulley sheave pairs.

Such V-belt pulley drives have been known for a long time. In operation of the V-belt pulley drive, the belt means is displaced on the pulley sheave pairs in a radial direction between an inner position and an outer position.

The belt means extends through the gap between the first pulley sheave pair and the second pulley sheave pair. Slide rails for guiding the belt means are provided in the gap. The slide rails are arranged both on the traction side and on the thrust side of the belt means. The slide rails are designed for acoustically efficient chain guidance (guidance of the belt means). Here, the length of guidance of the belt means and the stiffness of the slide rail are decisively influential factors.

Slide rails are typically composed of two slide rail halves. Each slide rail half has an outer piece and an inner piece. Alternatively, the slide rail may be composed of an outer belt means guide and an inner belt means guide, with each belt means guide having a first guide part (outer or inner piece) and a second guide part (outer or inner piece).

The slide rail halves, or first and second guide parts, may be assembled by means of two hooks which engage in associated receivers (windows) in the inner or outer chain guide (belt means guide) of the slide rail. The slide rail halves are thus guided together. Furthermore, a clip system is provided in the outer chain guide (belt means guide) in order to lock the slide rails in the joined state. Here four stops (hooks against windows) are provided in a first longitudinal (axial) direction, but in the second (axial) direction there is only one stop (clip against clip). In the first longitudinal (axial) direction there is a high torsional rigidity, while in the second (axial) direction there is a low torsional rigidity. Such a slide rail is known from WO 2014/012741 A1.

For the clip system described, an opening is required in the middle of the outer chain guide so that, because of the absent vertical rib and the lack of possibility of inserting additional ribs in the axial direction, the stiffness of the slide rail is reduced. The clip system may only be used on the outer chain guide, so the torsional rigidity of the slide rail is reduced and a relatively large pivot play is possible in operation. As a result, relatively large safety distances are required, and therefore the installation space for the slide rail is reduced. The stiffness of the slide rail is thus lower than would be possible because of the installation space available.

### SUMMARY

A slide rail is proposed for a V-belt pulley drive. The V-belt pulley drive includes at least a first pulley sheave pair arranged on a first shaft and a second pulley sheave pair arranged on a second shaft, and a belt means for transmitting torque between the pulley sheave pairs. The belt means can be displaced on each pulley sheave pair in a radial direction (transverse direction) between an inner position and an outer position on a support face of the pulleys. The belt means has an inside facing the shafts and an outside of opposite orientation, and extends in an axial direction (longitudinal direction).

The slide rail has an outer belt means guide which is arranged on the outside and an inner belt means guide which is arranged on the inside. At least one of the belt means guides consists of a first guide part and a second guide part which can be connected together via at least two hooks. At least one of the hooks is formed on the first guide part and has a contact face, and a receiver for the hook is formed on the second guide part and has a support face for the contact face. A separation of the guide parts can be prevented by a clip-tooth connection, acting in one of the axial directions, between the contact face and the support face.

In an example embodiment, the first guide parts (or the second guide parts) of an outer and an inner belt means guide each form a slide rail half. Each slide rail half may be designed as one piece.

With the proposed connection of the guide parts, oscillations of the belt means are further restricted or reduced.

In an example embodiment, the V-belt pulley drive includes at least a first pulley sheave pair arranged on a first shaft having a first shaft axis, and a second pulley sheave pair arranged on a second shaft having a second shaft axis. Each pulley sheave pair has a first pulley sheave which can be displaced along the respective shaft axis, and a second pulley sheave which is fixed in the direction of the shaft axis. Furthermore, a belt means (e.g. a chain) is provided for transmitting torque between the pulley sheave pairs, and the belt means can be displaced on each pulley sheave pair in a radial direction between an inner position and an outer position on a support face of the pulley sheaves. The belt means extends through a gap between the first pulley sheave pair and the second pulley sheave pair, with a traction side (here, in particular tensile stresses act on the belt means in the rotation direction of the belt means) and with a thrust side (here, in particular shear stresses act on the belt means in the rotation direction of the belt means). The traction side is guided via a first slide rail arranged in the gap, and the thrust side is guided by a second slide rail arranged in the gap.

In an example embodiment, the closing system is integrated in each hook. For this, the hooks themselves are provided with a latching device. This latching device may be equipped with one or more teeth. On the counter-hook side (i.e. the support face), a clip is provided which cooperates with the tooth or teeth. In total, four stops (against the axial directions) are provided (for each slide rail), which are present in both longitudinal (axial) directions so as to give a high torsional rigidity in both (axial) directions. In this way, a play in the first and/or second direction may be further restricted. Thus a greater torsional rigidity is created, and as a result less installation space is required.

The middle region of the outer chain guide (belt means guide) may be equipped with several stiffening elements, since here latching is no longer required, and the torsional rigidity of the slide rail and the stiffness in the radial direction (transverse direction) may be further increased.

As well as the direct increase in stiffness from larger ribs in comparison with the prior art, or from additional ribs, an indirect increase in stiffness may also be achieved by reducing the pivot play. A smaller safety distance is required so the permitted installation space for the slide rail may be increased.

Since the hooks may be equipped with one or more teeth, it is also possible to achieve a small play in the longitudinal (axial) direction with little need for correction for the injection-molding tool. A retaining rib (stop) may be inserted in order to prevent undesirable opening of the slide rail. A region on the hook (contact face) and on the counter-hook side (support face) is provided for adjusting the play transversely to the axial direction (by tool corrections).

In an example embodiment, an elastically deformable clip is formed on one of the support face and contact face. At least one tooth is formed on the other of the contact face and support face, and the clip and the at least one tooth create a form-fit clip-tooth connection against the one axial direction.

Form-fit connections arise by the intermeshing of at least two connection partners. In this way, the connection partners cannot become separated even without or in the case of an interrupted force transmission. In other words, with a form-fit connection, the one connection partner stands in the way of the other.

In an example embodiment, when the guide parts are joined (tooth moves e.g. in the first axial direction), the clip can be bent back by the one tooth so that the tooth can pass over the clip. After the tooth has passed over the clip, the clip springs back and creates a form-fit connection with the rear tooth flank (against the second axial direction).

In an example embodiment, a plurality of teeth are arranged successively in the axial direction. If more than one tooth is provided, a play between the guide parts may be set more precisely in the axial direction.

In an example embodiment, the contact face extends in the axial direction (and in the radial direction).

In an example embodiment, the receiver is limited by a stop (acting in the direction transversely to the radial direction and transversely to the axial directions), and the stop prevents deformation of the hook and hence separation of the clip-tooth connection.

In an example embodiment, each guide part comprises precisely one hook and one receiver.

The guide parts of both belt means guides can in particular be connected together via only two hooks and two receivers respectively. In particular, at least the first guide parts (or the second guide parts, preferably both) are connected together (in particular formed integrally). In particular, the assembly of the first guide parts can be connected together to an assembly of the second guide parts exclusively via four hooks and four receivers.

Furthermore, a V-belt pulley drive is proposed which includes at least a first pulley sheave pair arranged on a first shaft and a second pulley sheave pair arranged on a second shaft, and a belt means for transmitting torque between the pulley sheave pairs. The belt means can be displaced on each pulley sheave pair in a radial direction between an inner position and an outer position on a support face of the pulley sheave pair. The belt means has an inside facing the shafts and an outside of opposite orientation, and extends in an axial direction. The belt means is guided between the pulley sheave pairs at least by the slide rail already described.

Furthermore, a motor vehicle is proposed with the V-belt pulley drive described above.

The statements relating to the slide rail apply accordingly to the V-belt pulley drive and the motor vehicle, and vice versa.

As a precaution, it is pointed out that the numerical words used here (“first”, “second” etc.) are used primarily (only) to distinguish several similar objects, sizes or processes, i.e. in particular do not necessarily define a dependency and/or order of these objects, sizes or processes relative to each other. If a dependency and/or order is necessary, this is explicitly stated or is evident to the person skilled in the art from studying the specific embodiment described.

### BRIEF DESCRIPTION OF THE DRAWINGS

The disclosure and the technical environment are explained in more detail below with reference to figures. It is pointed out that the disclosure should not be restricted by the exemplary embodiments shown. In particular, unless otherwise explicitly stated, it is also possible to extract partial aspects of the situations explained in the figures, and combine these with other elements and knowledge from the present description and/or the figures. In particular, it is pointed out that the figures and in particular the size ratios depicted therein are merely diagrammatic. The same reference signs designate the same objects, so in some cases explanations from other figures may be used in addition. In the drawings:

FIG. 1 shows a motor vehicle with a V-belt pulley drive in a side view;

FIG. 2 shows the V-belt pulley drive from FIG. 1 viewed in the radial direction;

FIG. 3 shows a slide rail in perspective view, partially in cross section along line from FIG. 5;

FIG. 4 shows the slide rail from FIG. 3 viewed in the radial direction;

FIG. 5 shows the slide rail from FIGS. 3 and 4 viewed in the transverse direction;

FIG. 6 shows a slide rail viewed in the transverse direction;

FIG. 7 shows the slide rail from FIG. 6 in a perspective view;

FIG. 8 shows the slide rail from FIGS. 6 and 7 in a perspective view, partially in cross section along line VIII-VIII from FIG. 6;

FIG. 9 shows the slide rail from FIGS. 6 to 8 viewed in the radial direction;

FIG. 10 shows a detail from FIG. 9;

FIG. 11 shows the slide rail from FIGS. 6 to 10 viewed in the radial direction, before displacement of the first guide part and second guide part relative to each other in the axial directions; and

FIG. 12 shows the slide rail from FIG. 11 viewed in the radial direction, after displacement of the first guide part and second guide part relative to each other in the axial directions.

### DETAILED DESCRIPTION

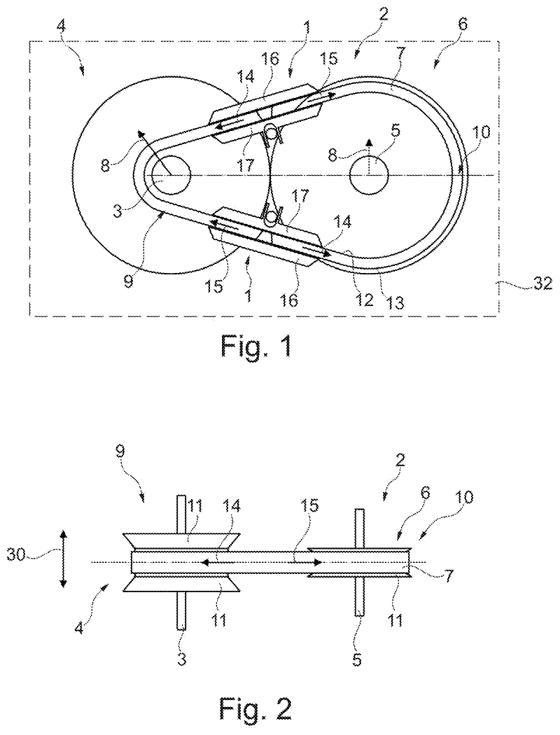

FIG. 1 shows a motor vehicle 32 with a first V-belt pulley drive 2 in side view. FIG. 2 shows the V-belt pulley drive 2 from FIG. 1 viewed in the radial direction 8.

The V-belt pulley drive 2 has a first pulley sheave pair 4 arranged on a first shaft 3 having a first shaft axis, and a second pulley sheave pair 6 arranged on a second shaft 5 having a second shaft axis. Each pulley sheave pair 4, 6 has a first pulley sheave which can be displaced along the respective shaft axis, and a second pulley sheave which is fixed in the direction of the shaft axis. Furthermore, a belt means 7 is provided (e.g. a chain) for transmitting torque between the pulley sheave pairs 4, 6. The belt means 7 can be displaced on each pulley sheave pair 4, 6 in a radial direction 8 (transverse direction) between an inner position 9 and an outer position 10 on the support face 11 of the pulley sheaves or pulley sheave pairs 4, 6. The belt means 7 extends with a traction side and with a thrust side through a gap between the first pulley sheave pair 4 and the second pulley sheave pair 6. The belt means 7 is guided over two slide rails 1 arranged in the gap.

The belt means 7 has an inside 12 facing the shafts 3, 5 and an outside 13 of opposite orientation, and extends in an axial direction 14, 15.

The slide rails 1 have an outer belt means guide 16 arranged on the outside 13 and an inner belt means guide 17 arranged on the inside 12.

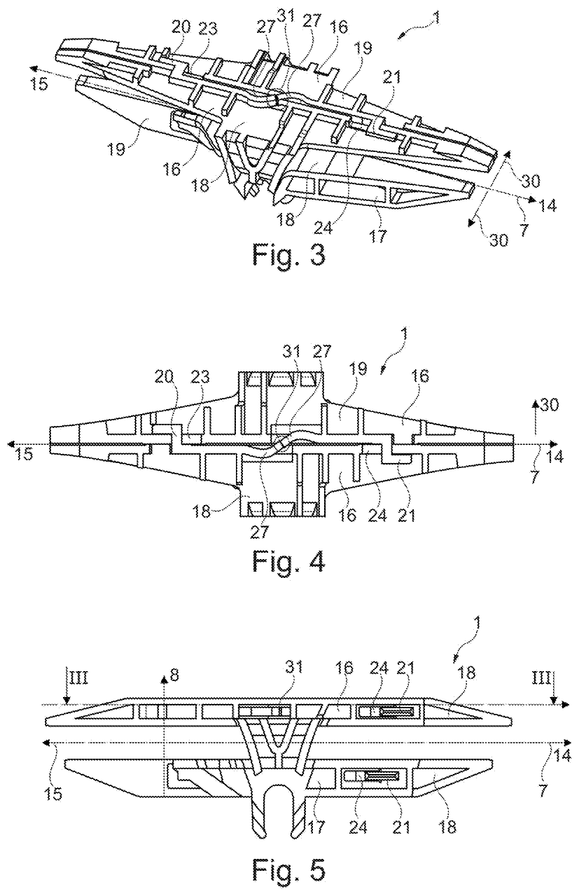

FIG. 3 shows a slide rail 1 in a perspective view, partially in cross section along line from FIG. 5. FIG. 4 shows the slide rail 1 from FIG. 3 in a view in the radial direction 8. FIG. 5 shows the slide rail 1 from FIGS. 3 and 4 viewed in the transverse direction 30 (axial direction). FIGS. 3 to 5 are described jointly below.

The slide rail 1 is composed of two slide rail halves. Each slide rail half has a first guide part 18 (or second guide part 19) of an outer belt means guide 16, and a first guide part 18 (or second guide part 19) of an inner belt means guide 17.

The slide rail halves, or first guide part 18 and second guide part 19, are joined together by means of two hooks 20, 21 which engage in associated receivers 23, 24 (windows) in the inner and outer chain guide (belt means guide 16, 17) of the slide rail 1. The slide rail halves are thus guided together. Furthermore, a clip system is provided in the outer chain guide (belt means guide 16) for locking the slide rail 1 in the joined state. In a first (longitudinal) axial direction 14, four stops are thus provided (hooks 20, 21 against windows or receivers 23, 24), but in the second (longitudinal) axial direction 15 there is only one stop (clip 27 against clip 27 of the clip connection 31). In the first (longitudinal) axial direction 14 there is a high torsional rigidity, while in the second (longitudinal) axial direction 15 there is a low torsional rigidity.

For this clip connection 31, an opening is required in the middle of the outer chain guide (belt means guide 16) so that because of an absent vertical rib and the lack of possibility of inserting additional ribs in the transverse direction 30, the stiffness of the slide rail 1 is reduced. The clip connection 31 may only be inserted in the outer chain guide (belt means guide 16) so that the torsional rigidity of the slide rail 1 is reduced and a relatively large pivot play is possible in operation. As a result, relatively large safety distances are required and therefore the installation space for the slide rail 1 is reduced. The stiffness of the slide rail 1 is thus lower than would be possible because of the installation space available.

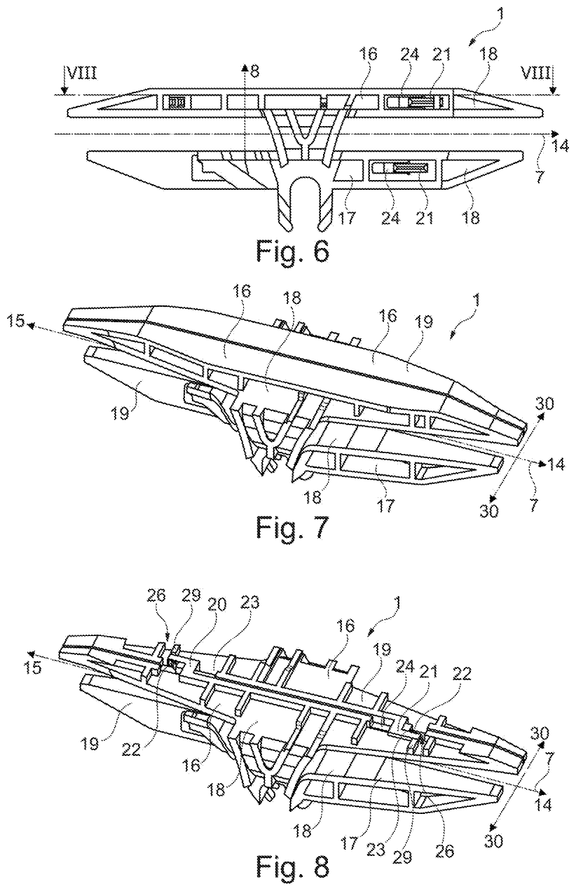

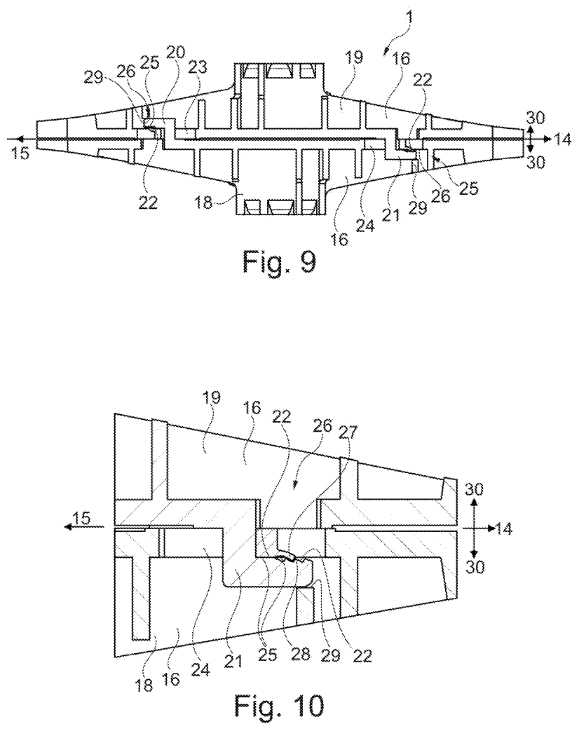

FIG. 6 shows a slide rail 1 in a view in the transverse direction 30. FIG. 7 shows the slide rail 1 from FIG. 6 in a perspective view. FIG. 8 shows the slide rail 1 from FIGS. 6 and 7 in a perspective view, partially in cross section along line VIII-VIII of FIG. 6. FIG. 9 shows the slide rail 1 from FIGS. 6 to 8 viewed in the radial direction 8. FIG. 10 shows a detail of FIG. 9. FIGS. 6 to 10 are described jointly below.

In particular, each of the belt means guides 16, 17 consists of a first guide part 18 and a second guide part 19 which can be connected together via two respective hooks 20, 21. A first hook 20 is formed on the first guide part 18 and has a contact face 22, and a first receiver 23 for the first hook 20 is formed on the second guide part 19 and has a support face 25 for the contact face 22. Separation of the guide parts 18, 19 can be prevented by a clip-tooth connection 26, acting in the second axial direction 15, between the contact face 22 and the support face 25. A second hook 21 is formed on the second guide part 19 and has a contact face 22. A second receiver 24 for the second hook 21 is formed on the first guide part 18 and has a support face 25 for the contact face 22.

The respective first guide parts 18 (or second guide parts 19) of an outer belt means guide 16 and of an inner belt means guide 17 each form a slide rail half. In the present case, the slide rail halves are configured as one piece, i.e. two first guide parts 18 (or two second guide parts 19) are connected together by substance bonding (i.e. already produced integrally).

A closing system for the slide rail 1 is integrated in each hook 21, 22. The hooks 20, 21 are themselves provided with a latching device. This latching device (clip-tooth connection 26) is equipped with several teeth 28. On the counter-hook side (i.e. the support face 25), a clip 27 is provided which cooperates with the teeth 28. A total of four stops (against the axial directions 14, 15) are provided (for each slide rail 1) in both (longitudinal) axial directions 14, 15, so as to give a high torsional rigidity in both axial directions 14, 15.

In this way, the middle region of the outer chain guide (belt means guide 16) may be equipped with several stiffening elements, since at this point latching is no longer required. In this way, the torsional rigidity of the slide rail 1 may be further increased.

Since the hooks 20, 21 are equipped with several teeth 28, there is also the possibility of achieving a small play in the (longitudinal) axial direction 14, 15 with little need for correction for the injection-molding tool. A retaining rib (stop 29) may be inserted to prevent undesirable opening of the slide rail 1. A region on the hook 20, 21 (contact face 22) and on the counter-hook side (i.e. support face 25) is provided for adjusting the play in the transverse direction 30 (by tool corrections).

Here, an elastically deformable clip 27 is formed on the support face 22, and a plurality of teeth 28 are formed on the contact face 22. The clip 27 and the teeth 28 create a form-fit clip-tooth connection 26 against the second axial direction 15 in the depiction of FIG. 10.

When the guide parts 18, 19 are joined (tooth 28 moves e.g. in the first axial direction 14), the clip 27 may be bent back by a tooth 28 so that the tooth 28 can pass over the clip 27. After the tooth 28 has passed over the clip 27, the clip 27 springs back and creates a form-fit connection with the rear tooth flank (against the second axial direction 15).

Here, a plurality of teeth 28 are arranged successively in the axial direction 14, 15. If more than one tooth 28 is provided, a play between the guide parts 18, 19 in the axial direction 14, 15 may be set more precisely.

The contact face 22 and the support face 25 extend in the axial direction 14, 15 and in the radial direction 8.

FIG. 10 shows that the second receiver 24 is delimited by a stop 29 (acting in the direction transversely to the radial direction 8 and transversely to the axial directions 14, 15). The stop 29 prevents deformation of the second hook 21 and hence separation of the clip-tooth connection 26.

As can be seen, each guide part 18, 19 comprises precisely one hook 20, 21 and one receiver 23, 24.

The guide parts 18, 19 of both belt means guides 16, 17 can be connected together via only two hooks 20, 21 and two receivers 23, 24 in each case. In the depictions shown, the first guide parts 18 and the second guide parts 19 are connected together, i.e. formed integrally. The assembly of the first guide parts 18 may be connected with an assembly of the second guide parts 19 via only four hooks 20, 21 and four receivers 23, 24.

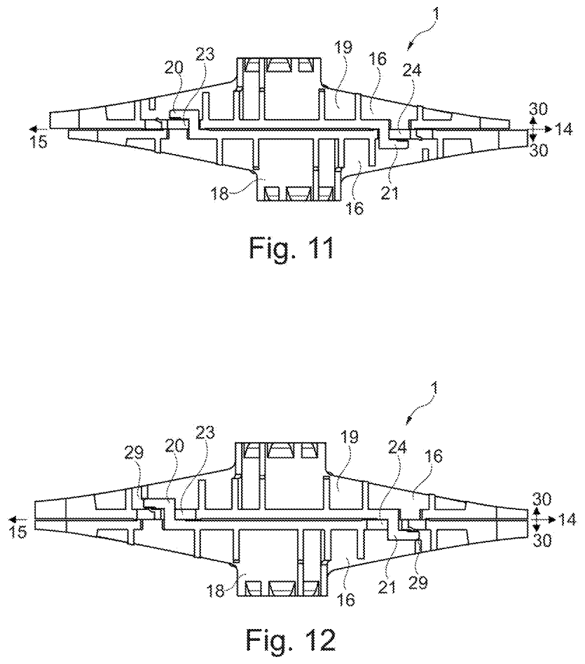

FIG. 11 shows the slide rail 1 from FIGS. 6 to 10 in a view in the radial direction 8, before the first guide part 18 and second guide part 19 are moved relative to each other in the axial directions 14, 15. FIG. 12 shows the slide rail 1 from FIG. 11 in a view in the radial direction 8, after the first guide part 18 and second guide part 19 have been moved relative to each other in the axial directions 14, 15. FIGS. 11 and 12 are described jointly below. Reference is made to the statements concerning FIGS. 6 to 10.

As can be seen, each guide part 18, 19 comprises precisely one hook 20, 21 and one receiver 23, 24. The first hook 20 is arranged in the first receiver 23, and the second hook 21 in the second receiver 24. Then the guide parts 18, 19 are moved relative to each other in the axial directions 14, 15. The contact faces 22 of the hooks 20, 21 thus slide along the support faces 25 of the receivers 23, 24.

On joining of the guide parts 18, 19 (teeth 28 of the second hook 21 move e.g. in the first axial direction 14; teeth 28 of the first hook 20 move in the second axial direction 15), the clips 27 can be bent back by the teeth 28 so the individual teeth 28 can pass over the clip 27. After the respective tooth 28 has passed over the clip 27, the clip 27 springs back and creates a form-fit connection with the rear tooth flank (against the second axial direction 15 in the case of the second hook 21, and against the first axial direction 14 in the case of the first hook 20).

### REFERENCE NUMERALS

1 Slide rail
2 V-belt pulley drive
3 First shaft
4 First pulley sheave pair
5 Second shaft
6 Second pulley sheave pair
7 Belt means
8 Radial direction (transverse direction)
9 Inner position
10 Outer position
11 Support face
12 Inside
13 Outside
14 First axial direction (longitudinal direction)
15 Second axial direction (longitudinal direction)
16 Outer belt means guide
17 Inner belt means guide
18 First guide part
19 Second guide part
20 First hook
21 Second hook
22 Contact face
23 First receiver
24 Second receiver
25 Support face
26 Clip-tooth connection
27 Clip
28 Tooth
29 Stop
30 Transverse direction (axial direction)
31 Clip connection
32 Motor vehicle

1.-9. (canceled)

10. A slide rail for a V-belt pulley drive, comprising:
an outer guide arranged for guiding an outside of an axially extending V-belt; and
an inner guide arranged for guiding an inside of the axially extending V-belt, wherein the outer guide or the inner guide comprises:
a first guide part comprising a first hook and a contact face; and
a second guide part comprising a first hook receiver and a support face, wherein the first guide part and the second guide part are connectable via the first hook and retained by a clip-tooth connection, acting in an axial direction, between the contact face and the support face.

11. The slide rail of claim 10 wherein the second guide part comprises a second hook and the first guide part comprises a second hook receiver.

12. The slide rail of claim 10 comprising:
an elastically deformable clip formed on a one of the support face or the contact face; and
at least one tooth formed on the other one of the support face or the contact face, wherein the elastically deformable clip and the at least one tooth create a form-fit clip-tooth connection against the axial direction.

13. The slide rail of claim 12, wherein the at least one tooth comprises a plurality of teeth arranged successively in the axial direction.

14. The slide rail of claim 10, wherein the contact face extends in the axial direction.

15. The slide rail of claim 10, wherein the first hook receiver is limited by a stop that prevents deformation of the first hook, thereby preventing separation of the clip-tooth connection.

16. The slide rail of claim 10, wherein the first guide part and the second guide part each comprise a single hook and a single receiver.

17. The slide rail of claim 10, wherein:
the outer guide includes the first guide part and the second guide part connected by the first hook and the first hook receiver and a second hook and a second hook receiver; and
the inner guide includes a third guide part and a fourth guide part connected by a third hook and a third receiver, and a fourth hook and a fourth receiver.

18. A V-belt pulley drive comprising:
a first pulley sheave pair arranged on a first shaft;
a second pulley sheave pair arranged on a second shaft; and
the axially extending V-belt for transmitting torque between the first pulley sheave pair and the second pulley sheave pair, displaceable on the first pulley sheave pair or the second pulley sheave pair in a radial direction between an inner position and an outer position, and comprising an inside facing the first shaft and the second shaft and an outside of opposite orientation; and
the slide rail of claim 10 arranged to guide the axially extending V-belt.

19. The V-belt pulley drive of claim 18 wherein the axially extending V-belt comprises a belt or chain.

20. A motor vehicle comprising the V-belt pulley drive of claim 18.
